(19) United States
(12) Patent Application Publication
(10) Pub. No.: US 2010/0328221 A1
(43) Pub. Date: Dec. 30, 2010

(54) Multiview display

(75) Inventors: Aki Happonen, Kiiminki (FI); Hannu Vilpponen, Järvenpää (FI); Timo Yli-Pietila, Tampere (FI); Henrik Hakala, Tampere (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/456,985

(22) Filed: Jun. 24, 2009

(51) Int. Cl. G09G 5/12; G06F 3/041

(52) U.S. Cl. 345/173; 345/1.1

(57) ABSTRACT

An apparatus with a multi view display. The display is configured to operate as a touch screen for receiving input and to provide multiple views, wherein content of a view depends on a viewing direction. The apparatus includes detection equipment detection equipment, and a processing unit. The detection equipment with the processing unit is configured to cause the apparatus to detect arrival direction of input received through said touch screen, and the processing unit is configured to control one of the views on said display responsive to said input received through said touch screen and to select which view to control based on the detected arrival direction of said input.

### TECHNICAL FIELD

The present invention generally relates to displays. The invention relates particularly, though not exclusively, to controlling of dual view or multi view displays.

### BACKGROUND ART

Dual view displays are a technology emerging e.g. in automotive industry. Dual view displays allow both the driver and front passenger to share a display so that both of them have their own view and both of them can use different applications at the same time. For example, the driver may view navigation directions, while the front passenger simultaneously watches a film on the exact same display.

In an example solution of dual displays, the different views are achieved by certain pixel placement. Two different images are shown simultaneously by placing pixels adjacent to one another, after which a filter masking the display divides this mixed image so that depending on the viewing direction or viewing angle, either one image or the other can be seen.

Typically, controlling the different views has been implemented by providing dedicated controls for both users. The users may have e.g. separate remote controllers, or one of the users may use controls of the display, while the other is using a separate remote controller.

JP2005284592 (A) provides a dual view display with a touch panel. The solution therein is to provide a non-overlapping control so that control icons of a user A and user B do not overlap. Thereby also this solution provides dedicated controls to both users.

### SUMMARY

According to a first example aspect of the invention there is provided an apparatus, comprising:

a display configured to operate as a touch screen for receiving input and to provide multiple views, wherein content of a view depends on a viewing direction;

detection equipment, and

a processing unit, wherein

the detection equipment with said processing unit is configured to cause the apparatus to detect arrival direction of input received through said touch screen, and

the processing unit is configured to control one of the views on said display responsive to said input received through said touch screen and to select which view to control based on the detected arrival direction of said input.

In an embodiment the detection equipment is configured to detect movements in vicinity of said display and said apparatus is caused to determine the arrival direction of said input received through said touch screen based on said movements.

In certain embodiments the detection equipment comprises a camera, or a detector configured to detect reflections from objects in vicinity of said display, or the detection equipment is included in physical structure of said display. A combination of these is possible as well.

In an embodiment the detection equipment with said processing is configured to cause the apparatus to detect characteristics of a finger touching said touch screen and to determine the arrival direction of said input received through said touch screen based on said characteristics.

In an embodiment the apparatus comprises direction specific detection equipment for each viewing direction.

In an embodiment the direction specific detection equipment are configured to detect movements in vicinity of said display and said apparatus is caused to determine the arrival direction of said input received through said touch screen based on identity of the direction specific detection equipment that has detected movements.

In an embodiment the detection equipment is configured to cover input from two or more viewing directions, i.e. the detection equipment is configured to detect movement and/or arrival direction of input originating from two or more viewing directions.

In an embodiment the apparatus is a mobile electronic device. The mobile electronic device may comprise a battery configured to power the apparatus. Additionally or alternatively, the mobile electronic device may comprise communication functionality. In certain other embodiments the apparatus is a car display, an entertainment device, an info kiosk, or other, either stationary or mobile, display apparatus.

According to a second example aspect of the invention there is provided a method comprising

displaying multiple views on a display, wherein content of a view depends on a viewing direction, said display operating as a touch screen;

accepting input through said touch screen,

detecting arrival direction of said input,

controlling one of the views on said display responsive to said input; and

selecting which view to control based on the detected arrival direction of said input.

According to a third example aspect of the invention there is provided a computer program comprising:

program code for displaying multiple views on a display, wherein content of a view depends on a viewing direction, said display operating as a touch screen;

program code for accepting input through said touch screen,

program code for detecting arrival direction of said input,

program code for controlling one of the views on said display responsive to said input; and

program code for selecting which view to control based on the detected arrival direction of said input.

The computer program may be stored on a computer readable memory medium. The memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Various example embodiments of the present invention are illustrated hereinafter in the detailed description of the invention as well as in the dependent claims appended hereto. The embodiments are illustrated with reference to selected aspects of the invention. A person skilled in the art appreciates that any embodiment of the invention may be combined with other embodiment(s) within the same aspect. Furthermore, any embodiment may apply to other aspects as well either alone or in combination with other embodiment(s).

### BRIEF DESCRIPTION OF THE DRAWINGS

The invention will be described, by way of example only, with reference to the accompanying drawings, in which:

FIG. 1 shows a block diagram of an example apparatus;

FIG. 2 shows a flow chart of an example method; and

FIG. 3 shows a schematic picture of an example device.

### DETAILED DESCRIPTION

In an embodiment of the invention a multi view display is provided with equipment for detecting movements near the display in order to enable use of a touch screen for controlling the multi view display. The detected movements are used for determining direction from which a hand or finger or other object (a stylus or a pen, for example) touching the display comes. The detected arrival direction is then used for determining which view is intended to be controlled. In this way there is no need to use differently positioned buttons (or other controls) for each user or to provide otherwise dedicated controls for each user.

The movement or direction detection can be implemented in various different ways. In some cases it suffices that only movement is detected (e.g. if there is dedicated detection equipment for each viewing direction) and in some cases it is necessary to detect both movement and direction of the movement. Some example implementation techniques are listed in the following:
Camera detection.
   A camera can be used for detecting movement, i.e. changes versus steady image. In some embodiments the camera can be a low cost camera.
   More sophisticated cameras are able to detect also direction of a movement or at least are able to provide data suitable for determining the direction of a movement.
   There may be one wide angle camera configured to cover all viewing directions or a dedicated camera for each viewing direction. A combination of these can be used as well.
Reflection detection by a transmitter-receiver pair.
   A radio/LED or the like transmitters and receivers can be configured to detect reflections from a nearby/approaching hand, finger or other object. The reflections can be used for detecting movement and its direction.
   An infrared (IR) detector is a photodetector that reacts to infrared radiation. A movement of a body part or other heat source causes changes in strength of infrared radiation in the surroundings. An IR detector can be configured to detect those changes and thereby to detect movements.
   An ultrasonic/ microwave detector transmits ultrasound/microwave pulses and receives echo of the pulses. Such detector can detect movements based on changes on the received echo.
A touch screen implementation suitable for movement detection.
   A capacitive touch screen is a sensor typically made of glass coated with a material such as indium tin oxide. This type of sensor is basically a capacitor in which the plates are the overlapping areas between the horizontal and vertical axes in a grid pattern. Since the human body also conducts electricity, a touch on the surface of the sensor will affect the electric field and create a measurable change in the capacitance of the device. These sensors work on proximity, and do not have to be directly touched to be triggered. Such capacitive touch screen can be configured to detect approaching finger and thus also direction from which the touching finger comes.
Detection based on a shape of a touching finger.
   Shape of a touching finger depends on the direction of the touching hand. I.e. a fingerprint seen at the display includes information about the input direction.
Combination of two or more above mentioned techniques.
   It may be possible to improve detection reliability by combining different types of movement and/or direction detection techniques. In that way, for example, probability of false detection of input direction may be reduced.

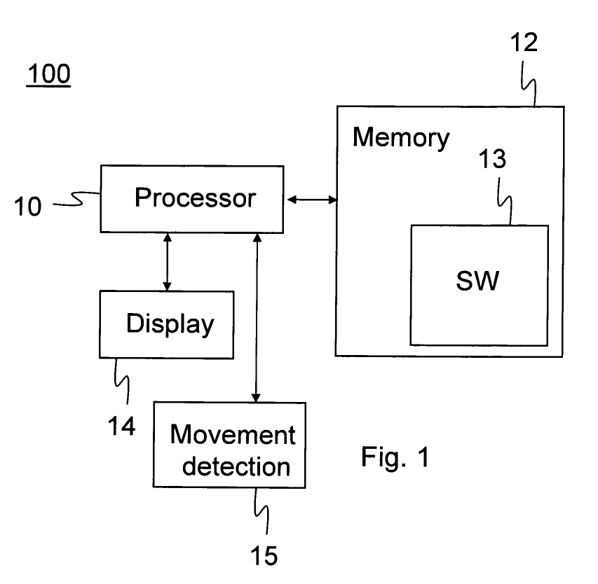

FIG. 1 shows a block diagram of an example apparatus 100 in which certain embodiments of the invention may be applied. The apparatus may be a car display, an entertainment device, a general purpose display device, a handheld device, a mobile electronic device, or the like.

The general structure of the apparatus 100 comprises a display 14, a processor 10 coupled to the display 14, and a memory 12 coupled to the processor 10. The apparatus further comprises software 13 stored in the memory 12 and operable to be loaded into and executed in the processor 10. The software 13 may comprise one or more software modules and can be in the form of a computer program product. The apparatus 100 further comprises a movement detection module 15 coupled to the processor 10.

The processor 10 may be, e.g., a central processing unit (CPU), a microprocessor, a digital signal processor (DSP), a graphics processing unit, or the like. FIG. 1 shows one processor 10, but the apparatus 100 may comprise a plurality of processors.

The memory 12 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 100 may comprise a plurality of memories. The memory 12 may be constructed as a part of the apparatus 100 or it may be inserted into a slot, port, or the like of the apparatus 100 by a user. The memory 12 may serve the sole purpose of storing data, or it may be constructed as a part of an apparatus serving other purposes, such as processing data.

The display 14 is a multi view display providing different view depending on the viewing direction. The display may be a dual view display or a quad view display, for example. Furthermore, the display 14 provides a touch screen for receiving user input and/or for controlling the display.

The movement detection module 15 comprises equipment configured to detect movements near the display 14. The movement detection module 15 may be configured to detect direction of movements as well. The movement detection module 15 may be part of the display 14 or a separate module.

The movement detection module 15 may include a camera configured to detect movement, i.e. the camera is configured to detect changes versus a steady image. There may be a dedicated camera for each viewing direction or a wide angle camera for detecting movements from all directions. In another option, the movement detection module 15 comprises a radio/LED or the like transmitter and receiver configured to detect reflections from a hand/finger (or other object) approaching the display 14. In another alternative, detection of an approaching hand/finger (or other object) is a functionality included in the display 14. In such case, a physically separate movement detection module might not be needed.

In an alternative solution the movement detection module 15 may be replaced by a direction detection functionality as detection of movement is not necessarily mandatory. E.g. detection of arrival direction based on shape of a touching finger does not necessarily require movement detection.

A skilled person appreciates that in addition to the elements shown in FIG. 1. For example, the apparatus may comprise further user interface equipment (not shown). The user interface equipment may comprise circuitry for receiving input from a user of the apparatus 100, e.g., via a keyboard, a mouse, a speech recognition circuitry, or an accessory device, such as a headset, and for providing output to the user via, e.g., a graphical user interface or a loudspeaker.

The apparatus may further comprise one or more communication interface modules (not shown). The communication interface module may be, e.g., a radio interface module, such as a WLAN, Bluetooth, GSM/GPRS, CDMA, or WCDMA radio module. The communication interface module may be integrated into the apparatus 100 or into an adapter, card or the like that may be inserted into a suitable slot or port of the apparatus 100. The communication interface module may support one radio interface technology or a plurality of technologies.

Still further, the apparatus 100 may comprise other elements, such as microphones, as well as additional circuitry such as input/output (I/O) circuitry, memory chips, application-specific integrated circuits (ASIC), processing circuitry for specific purposes, and the like. Additionally, the apparatus 100 may comprise a disposable or rechargeable battery (not shown) for powering the apparatus 100 when external power if external power supply is not available.

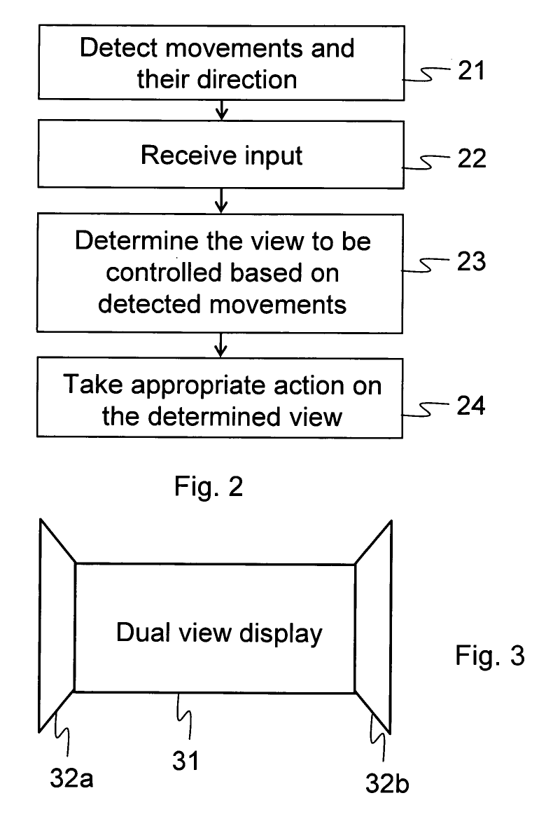

FIG. 2 shows a flow chart of an example method in a multi view display arrangement.

In phase 21, movements in vicinity of a multi view display and directions of the movements are detected by suitable detection equipment, such as a camera or IR detectors. In phase 22, input is received through a touch screen implemented in the multi view display. In phase 23, the view that is to be controlled is determined on the basis of movement(s) and their direction(s) previously detected near the display. Information relating to the movements detected near the display may have been stored for this purpose in phase 21. Typically, temporary storing of such information suffices because only movements that take place right before receiving input are relevant. In phase 24, an appropriate action is then taken on the determined view. The input has no impact on the other view(s).

FIG. 3 shows a schematic picture of an example device. The device comprises a dual view display 31 and detection beams 32a and 32b on each side of the display. (For a multi-view display there might be a detection beam for each viewing side or angle.) The detection beams 32a and 32b detect movements and provide this information for use in determining which view is to be controlled, when input is received through a touch screen implemented on the display 31.

The detection beams 32a and 32b may be implemented by means of cameras, suitable transmitters and receivers, or the like movement detection equipment. The beams may detect movements only or also directions of movements. It may suffice that the beams simply detect movement and the direction of the movement is determined on the basis of the beam that detected the movement. I.e. the beams do not necessarily need to be able to detect direction of a movement.

In an alternative solution there is only one detection “beam” (a wide angle beam) covering all viewing directions. In such case, the beam is configured to detect both movement and directions of the movement.

In an embodiment the display is a quad view display. In an example a quad view display is used in info kiosks in a table so that four persons can use the info kiosk at the same time without disturbing each other. Here all four persons see their own content and are able to control that by touching the screen. Direction of control is detected and the system responds accordingly.

A multi-view display of embodiments of the invention can be used for various purposes. The display may be used in cars so that the driver has access to controls of the car or navigation directions, for example, and the passenger can use the display for entertainment purposes. Such display may be an integral part of the car or it can be mobile in the sense that passengers can take it with them when leaving the car. In another case, there is own browser for all users (two or more users using the display from different direction) and all users can simultaneously surf web pages with their own browser. In yet another case, the display is used for playing a card game. Therein all users see only their own playing cards and cards on the table, but not cards of the other players. In the latter two examples the display can be implemented in a mobile electronic device/handheld device or in a stationary apparatus.

In an embodiment a multi view display is used by one user only. The multi view display may be implemented for example in a personal device, such as a mobile phone or other mobile electronic device. In such case the user can change the view on the display for example by tilting the device into another position. In this way the user changes the viewing direction by moving the device into another position.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description should be considered as merely illustrative of the principles of the present invention, and not in limitation thereof. Hence, the scope of the invention is only restricted by the appended patent claims.

1. An apparatus, comprising:
a display configured to operate as a touch screen for receiving input and to provide multiple views, wherein content of a view depends on a viewing direction;
detection equipment, and
a processing unit, wherein
said detection equipment with said processing unit is configured to cause the apparatus to detect arrival direction of input received through said touch screen, and
said processing unit is configured to control one of the views on said display responsive to said input received through said touch screen and to select which view to control based on the detected arrival direction of said input.

2. An apparatus according to claim 1, wherein said detection equipment is configured to detect movements in vicinity of said display and said apparatus is caused to determine the arrival direction of said input received through said touch screen based on said movements.

3. An apparatus according to claim 1, wherein said detection equipment comprises a camera.

4. An apparatus according to claim 1, wherein said detection equipment comprises a detector configured to detect reflections from objects in vicinity of said display.

5. An apparatus according to claim 1, wherein said detection equipment is included in physical structure of said display.

6. An apparatus according to claim 1, wherein said detection equipment with said processing unit is configured to cause the apparatus to detect characteristics of a finger touching said touch screen and to determine the arrival direction of said input received through said touch screen based on said characteristics.

7. An apparatus according to claim 1, wherein said apparatus comprises direction specific detection equipment for each viewing direction.

8. An apparatus according to claim 7, wherein said direction specific detection equipment are configured to detect movements in vicinity of said display and said apparatus is caused to determine the arrival direction of said input received through said touch screen based on identity of the direction specific detection equipment that has detected movements.

9. An apparatus according to claim 1, wherein said detection equipment is configured to cover input from two or more viewing directions.

10. An apparatus according to claim 1, wherein said apparatus is a mobile electronic device.

11. An apparatus according to claim 10, wherein said mobile electronic device comprises a battery configured to power the apparatus.

12. A method comprising:
displaying multiple views on a display, wherein content of a view depends on a viewing direction, said display operating as a touch screen;
accepting input through said touch screen,
detecting arrival direction of said input,
controlling one of the views on said display responsive to said input; and
selecting which view to control based on the detected arrival direction of said input.

13. A method according to claim 12, further comprising
detecting movements in vicinity of said display; and
determining the arrival direction of said input based on said movements.

14. A method according to claim 12, further comprising using a camera in said detection of arrival direction.

15. An apparatus according to claim 12, further comprising performing said detection of arrival direction on the basis of reflections from objects in vicinity of said display.

16. A method according to claim 12, further comprising using in said detection of arrival direction detection equipment comprising direction specific detection equipment for each viewing direction.

17. A method according to claim 16, further comprising
detecting movements in vicinity of said display by means of said direction specific detection equipment, and
determining the arrival direction of said input based on identity of the direction specific detection equipment that has detected movements.

18. A memory medium embodying a computer program executable in an apparatus, the computer program comprising:
program code for displaying multiple views on a display, wherein content of a view depends on a viewing direction, said display operating as a touch screen;
program code for accepting input through said touch screen,
program code for detecting arrival direction of said input,
program code for controlling one of the views on said display responsive to said input; and
program code for selecting which view to control based on the detected arrival direction of said input.

19. A memory medium according to claim 18, wherein the computer program further comprises
program code for detecting movements in vicinity of said display; and
program code for determining the arrival direction of said input based on said movements.
